(19) United States
(12) Patent Application Publication
(10) Pub. No.: US 2025/0308824 A1
(43) Pub. Date: Oct. 2, 2025

(54) FUSE MANUFACTURING METHOD

(71) Applicant: DONG GUAN RICHWILL ELECTRONICS TECHNOLOGY CO., LTD, Dongguan (CN)

(72) Inventors: Shikun YE, Dongguan (CN); Tengfei LI, Dongguan (CN); Tiesheng HUANG, Dongguan (CN)

(21) Appl. No.: 19/236,708

(22) Filed: Jun. 12, 2025

Related U.S. Application Data
(63) Continuation of application No. PCT/CN2023/096528, filed on May 26, 2023.

(30) Foreign Application Priority Data
Mar. 14, 2023 (CN) 202310241395.3

(51) Int. Cl. H01H 69/02

(52) U.S. Cl. CPC H01H 69/02

(57) ABSTRACT

A fuse manufacturing method using a machine tool, the machine tool including a control device, a wire feeding assembly, a circular cutting assembly, a laminating assembly and a wire winding assembly. The fuse manufacturing method includes the following steps. Shapes and sizes of a plurality of target metal conductors in a target fuse are obtained. The circular cutting assembly is selected to match the shapes and sizes. A to-be-processed fuse material is fed from the wire feeding assembly. A metal conductor of the to-be-processed fuse material is processed by the circular cutting assembly to obtain the plurality of target metal conductors corresponding to the target fuse. The plurality of target metal conductors and an insulating film assembly are positioned at a target location on the laminating assembly and laminated by the laminating assembly to form the target fuse. The target fuse is wound by the wire winding assembly.

### CROSS-REFERENCE TO RELATED APPLICATIONS

This application is a continuation of International Patent Application No. PCT/CN2023/096528, filed on May 26, 2023, which claims the benefit of priority from Chinese Patent Application No. 202310241395.3, filed on Mar. 14, 2023. The content of the aforementioned application, including any intervening amendments thereto, is incorporated herein by reference in its entirety.

### TECHNICAL FIELD

This application relates to manufacturing of automobile parts, and more particularly to a fuse manufacturing method.

### BACKGROUND

Automotive fuses involve two critical operation parameters: rated current and rated voltage. In practical applications, it is required to select an appropriate fuse based on the circuit's current and voltage to ensure the safe operation.

Automotive fuses generally adopt a blade-type design, which includes an engineering plastic housing and a zinc or copper fuse element encapsulated therein. The fuse element is connected to a blade terminal.

In the conventional manufacturing processes, multiple copper wires are first surface-mounted to keep the fuse position fixed, and further processed into the desired shape and size. This method has simple operation and low process requirements. However, this manufacturing process will make the fuse exposed (i.e., not covered by the insulating film), thereby resulting in oxidation.

### SUMMARY

An object of the disclosure is to provide a fuse manufacturing method to overcome the defects in the prior art that the fuse products are prone to oxidation in the industrial production.

Technical solutions of the present disclosure are described as follows.

A fuse manufacturing method using a machine tool, the machine tool comprising a control device, a wire feeding assembly, a circular cutting assembly, a laminating assembly and a wire winding assembly; the wire feeding assembly, the circular cutting assembly, the laminating assembly and the wire winding assembly being electrically connected to the control device; and the fuse manufacturing method comprising:
obtaining shapes and sizes of a plurality of target metal conductors in a target fuse;
selecting the circular cutting assembly to match the shapes and sizes;
feeding a to-be-processed fuse material from the wire feeding assembly;
processing, by the circular cutting assembly, a metal conductor of the to-be-processed fuse material to obtain the plurality of target metal conductors corresponding to the target fuse;
positioning the plurality of target metal conductors and an insulating film assembly at a target location on the laminating assembly; and laminating, by the laminating assembly, the plurality of target metal conductors and the insulating film assembly to form the target fuse; and
winding, by the wire winding assembly, the target fuse.

In some embodiments, the laminating assembly comprises a support structure, a first insulating film conveying structure, a second insulating film conveying structure, a metal conductor conveying structure, a first thermal pressing structure, and a traction structure;
the support structure is sequentially provided with the first insulating film conveying structure, the first thermal pressing structure, the second insulating film conveying structure, and the traction structure in a first direction;
the support structure is sequentially provided with the first insulating film conveying structure and the metal conductor conveying structure in a second direction;
the first insulating film conveying structure and the second insulating film conveying structure are respectively provided on two sides of the first thermal pressing structure, and are spatially-symmetrically arranged with respect to the first thermal pressing structure; and
center axes of the first insulating film conveying structure, the second insulating film conveying structure, the metal conductor conveying structure, the first thermal pressing structure and the traction structure are located in a plane in a conveying direction.

In some embodiments, the insulating film assembly comprises a first insulating film and a second insulating film both made of polyethylene (PE); and
the step of positioning the plurality of target metal conductors and the insulating film assembly at the target location on the laminating assembly, and laminating, by the laminating assembly, the plurality of target metal conductors and the insulating film assembly to form the target fuse comprises:
positioning the plurality of target metal conductors at a target position on the metal conductor conveying structure;
positioning the first insulating film at a target position on the first insulating film conveying structure;
positioning the second insulating film at a target position on the second insulating film conveying structure; and
simultaneously conveying the first insulating film, the plurality of target metal conductors and the second insulating film to the first thermal pressing structure respectively through the first insulating film conveying structure, the metal conductor conveying structure and the second insulating film conveying structure, so as to form a laminated structure; and pressing, by the first thermal pressing structure, the laminated structure to obtain the target fuse.

In some embodiments, the laminating assembly further comprises a first reinforcing structure and a second reinforcing structure;
in the conveying direction, center axes of the first reinforcing structure and the second reinforcing structure are located in the plane; and
the fuse manufacturing method further comprises:
reinforcing the target fuse by the first reinforcing structure and the second reinforcing structure.

In some embodiments, the first insulating film conveying structure comprises an insulating film placement shaft, a tension regulator, and a punching die sequentially arranged on the support structure;
the insulating film placement shaft is arranged spatially symmetrically with respect to a center axis of the first insulating film conveying structure; the tension regulator is arranged spatially symmetrically with respect to the center axis of the first insulating film conveying structure; and the punching die is arranged spatially symmetrically with respect to the center axis of the first insulating film conveying structure;
the insulating film placement shaft is configured to detachably mount the first insulating film; and
the step of positioning the first insulating film at the target position on the first insulating film conveying structure comprises:
placing the first insulating film on the insulating film placement shaft;
winding the first insulating film around the tension regulator and fixing the first insulating film to the punching die;
obtaining shape and size of the target fuse and shape and size of the to-be-processed fuse material;
determining a target tension range based on the shape and size of the target fuse, the shape and size of the to-be-processed fuse material, and a punching scheme of the first insulating film; and
adjusting the tension regulator to maintain a tension applied to the first insulating film within the target tension range.

In some embodiments, the second insulating film conveying structure comprises an insulating film placement shaft, a tension regulator and a punching die sequentially arranged on the support structure;
the insulating film placement shaft is arranged spatially symmetrically with respect to a center axis of the second insulating film conveying structure; the tension regulator is arranged spatially symmetrically with respect to the center axis of the second insulating film conveying structure; and the punching die is arranged spatially symmetrically with respect to the center axis of the second insulating film conveying structure;
the insulating film placement shaft is configured to detachably mount the second insulating film; and
the step of positioning the second insulating film at the target position on the second insulating film conveying structure comprises:
positioning the second insulating film on the insulating film placement shaft;
winding the second insulating film around the tension regulator and fixing the second insulating film to the punching die;
obtaining shape and size of the target fuse and shape and size of the to-be-processed fuse material;
determining a target tension range based on the shape and size of the target fuse, the shape and size of the to-be-processed fuse material, and a punching scheme of the second insulating film; and
adjusting the tension regulator to maintain a tension applied to the second insulating film within the target tension range.

In some embodiments, the metal conductor conveying structure comprises a wire frame, a first pitch rod, a wire guide roller and a second pitch rod; and the first pitch rod, the wire guide roller and the second pitch rod are arranged sequentially and spaced apart on the wire frame;
the first pitch rod, the wire guide roller and the second pitch rod are rotatably provided on the support structure; and
the step of positioning the plurality of target metal conductors at the target position on the metal conductor conveying structure comprises:
arranging the plurality of target metal conductors onto a pin position of the first pitch rod;
engaging the plurality of target metal conductors into a groove of the wire guide roller; and
arranging the plurality of target metal conductors led out from the wire guide roller onto a pin position of the second pitch rod to position the plurality of target metal conductors at the target position on the metal conductor conveying structure.

In some embodiments, the first thermal pressing structure comprises a first cooling tube set, a thermal pressing roller set and a second cooling tube set arranged spaced apart in the first direction;
the first thermal pressing structure is rotatably mounted on the support structure;
the thermal pressing roller set comprises at least two thermal pressing rollers arranged spaced apart at a predetermined distance in the second direction; and
the step of simultaneously conveying the first insulating film, the plurality of target metal conductors and the second insulating film to the first thermal pressing structure respectively through the first insulating film conveying structure, the metal conductor conveying structure and the second insulating film conveying structure to form a laminated structure, and pressing, by the first thermal pressing structure, the laminated structure to obtain the target fuse comprises:
conveying the first insulating film, the plurality of target metal conductors and the second insulating film respectively to a space between cooling tubes of the first cooling tube set for cooling;
conveying the first insulating film, the plurality of target metal conductors and the second insulating film to a space between any adjacent two of the at least two thermal pressing rollers in a laminated manner for thermal pressing to form the target fuse; and
conveying the target fuse to a space between any adjacent two cooling tubes of the second cooling tube set for cooling.

In some embodiments, the machine tool further comprises a second thermal pressing structure and an isolation film placement shaft;
the second thermal pressing structure is provided between the second insulating film conveying structure and the traction structure;
the isolation film placement shaft is provided above the second thermal pressing structure, and is configured for placement of a first isolation film and a second isolation film;
the second thermal pressing structure comprises a first cooling tube set, a thermal pressing roller set and a second cooling tube set arranged spaced apart in the first direction;
the second thermal pressing structure is rotatably mounted on the support structure;
the thermal pressing roller set comprises at least two thermal pressing rollers arranged spaced apart at a first predetermined distance in the second direction; and
the fuse manufacturing method further comprises:
after the target fuse is formed in the first thermal pressing structure, conveying the first isolation film, the target fuse and the second isolation film respectively to a space between cooling tubes of the first cooling tube set for cooling;
conveying the first isolation film, the target fuse and the second isolation film in a laminated manner to a space between any adjacent two of the at least two thermal pressing rollers for thermal pressing to form a finished fuse product; and
conveying the finished fuse product to a space between any adjacent two cooling tubes of the second cooling tube set for cooling.

In some embodiments, the traction structure comprises a balancing pressure roller set and a traction roller arranged spaced apart in the second direction; and the balancing pressure roller set and the traction roller are rotatably provided on the support structure;
the balancing pressure roller set comprises at least two balancing pressure rollers arranged spaced apart at a second predetermined distance in the second direction;
the wire winding assembly comprises at least one reel and at least two wire guide rollers;
the step of winding the target fuse by the wire winding assembly comprises:
preparing a plurality of target fuses, and processing the plurality of target fuses into a target fuse strip;
winding the target fuse strip around each of the at least two balancing pressure rollers to position a tail end of the target fuse strip at an inlet side of the balancing pressure roller set and a head end of the target fuse strip at an outlet side of the balancing pressure roller set; and
winding the target fuse strip onto the at least one reel via the at least one wire guide roller.

In some embodiments, the circular cutting processing assembly comprises a circular cutting mounting frame, a first circular cutting mold, and a second circular cutting mold. The first circular cutting mold and the second circular cutting mold are detachably mounted on the circular cutting mounting frame. The first circular cutting mold is configured to cooperate with the second circular cutting mold;
the first circular cutting mold is provided with a plurality of grooves corresponding to the number of target metal conductors in the target fuse; or
the second circular cutting mold is provided with a plurality of grooves corresponding to the number of target metal conductors in the target fuse; or
a plurality of grooves provided on the first circular cutting mold and the second circular cutting mold corresponds to the number of target metal conductors in the target fuse.

In some embodiments, in a region near the first thermal pressing structure, a conveying surface of the metal conductor conveying structure is parallel to a conveying surface of the first insulating film conveying structure and a conveying surface of the second insulating film conveying structure, respectively.

In some embodiments, each component of the first insulating film conveying structure and the second insulating film conveying structure is arranged symmetrically with respect to the first thermal pressing assembly, so as to achieve more controllable tension balance.

Compared to the prior art, the present disclosure has the following beneficial effects.

The metal conductor of the to-be-processed fuse material is processed by the circular cutting assembly to obtain the plurality of target metal conductors corresponding to the target fuse. The plurality of target metal conductors and the insulating film assembly are positioned at the target position on the laminating assembly. The plurality of target metal conductors and the insulating film assembly are laminated by the laminating assembly to form the target fuse. The target fuse is wound by the winding assembly. This configuration effectively prevents the processed target fuse from being exposed to ambient air, thereby mitigating the risk of oxidation.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a flowchart of a fuse manufacturing method according to an embodiment of the present disclosure;

FIG. 2 is a structural diagram of a machine tool applicable to the fuse manufacturing method according to an embodiment of the present disclosure;

FIG. 3 is a flowchart of the fuse manufacturing method according to another embodiment of the present disclosure;

FIG. 4 is a flowchart of the fuse manufacturing method according to another embodiment of the present disclosure;

FIG. 5 is a flowchart of the fuse manufacturing method according to another embodiment of the present disclosure;

FIG. 6 is a flowchart of the fuse manufacturing method according to another embodiment of the present disclosure;

FIG. 7 is a flowchart of the fuse manufacturing method according to another embodiment of the present disclosure;

FIG. 8 is a flowchart of the fuse manufacturing method according to another embodiment of the present disclosure;

FIG. 9 is a partial physical structure diagram of a finished product manufactured by the fuse manufacturing method according to an embodiment of the present disclosure;

FIG. 10 is a partial structural diagram of the finished product manufactured by the fuse manufacturing method according to an embodiment of the present disclosure; and

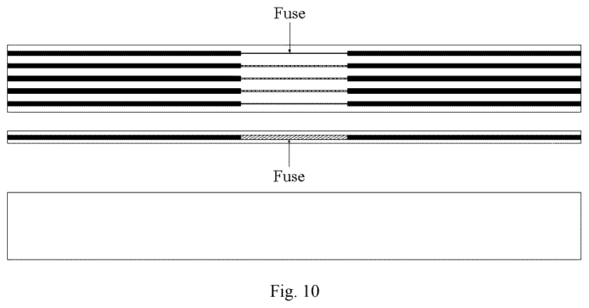

FIG. 11 is a partial structure diagram of the machine tool applicable to the fuse manufacturing method according to an embodiment of the present disclosure.

### DETAILED DESCRIPTION OF EMBODIMENTS

It should be understood that the following description is provided for illustrative purposes only and is not intended to limit the scope of the present disclosure. Specific system configurations, structural arrangements and technical details are provided to facilitate a thorough understanding of the described embodiments. However, it should be apparent to those skilled in the art that the present disclosure may be implemented without these specific details. In other instances, well-known systems, devices, circuits and methods are not described in detail so as not to obscure the essence of the present disclosure.

It should be understood that, as used herein, the term “comprise” refers to the presence of the recited features, entities, steps, operations, elements, and/or components, but does not exclude the presence or addition of one or more other features, entities, steps, operations, elements, components, and/or combinations thereof.

It should be understood that, as used herein, the term “and/or” refers to any one or more of the associated listed items and all possible combinations thereof, and is intended to be inclusive of all such combinations.

As used herein, the term “if” refers to “when”, “upon”, “in response to determining” or “in response to detecting” depending on the present disclosure. The phrases “if it is determined” or “if it is detected (that a condition or event occurs)” refer to “upon determining”, “in response to determining”, “upon detecting (the condition or event)” or “in response to detecting (the condition or event)” depending on the present disclosure.

As used herein, terms such as “first”, “second” and “third” are only descriptive, and should not be construed as indicating or implying their relative importance or implicitly specifying the number of technical features indicated.

As used herein, the terms “an embodiment” and “some embodiments” refer to one or more embodiments that include specific features, structures, or characteristics described in connection therewith. As a result, the appearances of the phrases “in an embodiment” and “in some embodiments” throughout this specification do not necessarily all refer to the same embodiment, unless otherwise explicitly stated. The terms “comprise”, “include” and “have” are intended to be open-ended and mean “including but not limited to,” unless expressly specified otherwise.

An embodiment of the present disclosure provides a fuse manufacturing method that can be applied to production equipment such as a machine tool. The specific type of terminal equipment is not limited in the embodiments of the present disclosure.

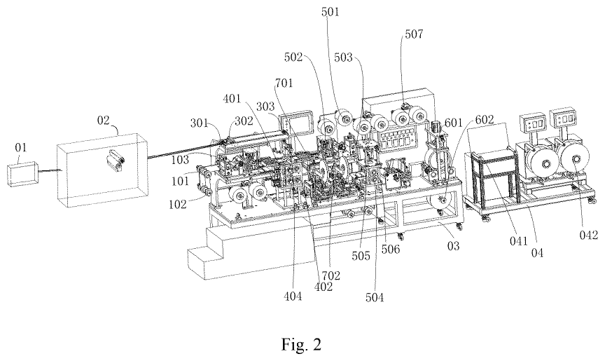

The following provides a detailed description of various components of the machine tool shown in FIG. 2.

The machine tool includes a control device and a wire feeding assembly 01, a circular cutting assembly 02, a laminating assembly 03 and a wire winding assembly 04. The wire feeding assembly 01, the circular cutting assembly 02, the laminating assembly 03 and the wire winding assembly 04 are respectively electrically connected to the control device.

The control device can be implemented using existing hardware compatible with machine tool automation control systems, such as various control chips or control terminals. The wire feeding assembly 01, the circular cutting assembly 02, the laminating assembly 03, and the wire winding assembly 04 are sequentially arranged spaced apart in a first direction within the workshop. The wire feeding assembly 01 is provided with a plurality of wire racks, each of the plurality of wire racks is configured to hold a plurality of metal conductor coils and guides a leading end of each of the metal conductor coils through a primary wire guide roller to achieve wire arrangement. The circular cutting assembly 02 is configured to process the metal conductor to obtain a plurality of target metal conductors. The laminating assembly 03 is configured to perform thermal pressing of a first insulating film, a second insulating film, a first isolation film and a second isolation film onto the processed target metal conductors, thereby isolating the processed target metal conductors from the external environment to achieve anti-oxidation. During the production process, the first insulating film, the second insulating film, the first isolation film and the second isolation film are all continuous products. The finished product is wound by the wire winding assembly 04 to enable batch production, convenient storage and transportation.

In an embodiment, the laminating assembly includes a support structure, a first insulating film conveying structure, a second insulating film conveying structure, a metal conductor conveying structure, a first thermal pressing structure, a second thermal pressing structure and a traction structure. The support structure is sequentially provided with the first insulating film conveying structure, the first thermal pressing structure, the second insulating film conveying structure, the second thermal pressing structure and the traction structure in a first direction. The support structure is sequentially provided with the first insulating film conveying structure and the metal conductor conveying structure in a second direction.

The first insulating film conveying structure and the second insulating film conveying structure are respectively provided on two sides of the first thermal pressing structure, and are spatially-symmetrically arranged with respect to the first thermal pressing structure. Center axes of the first insulating film conveying structure, the second insulating film conveying structure, the metal conductor conveying structure, the first thermal pressing structure, the second thermal pressing structure, and the traction structure are located in a plane in a conveying direction.

Specifically, the first direction and the second direction are arranged at an angle with respect to each other, thereby enabling a spatially rational arrangement of the support structure, the first insulating film conveying structure, the second insulating film conveying structure, the metal conductor conveying structure, the first thermal pressing structure, the second thermal pressing structure and the traction structure. This configuration prevents potential entanglement or mutual interference during the conveying of the first insulating film, the second insulating film and the target metal conductors. Specifically, the first insulating film conveying structure and the second insulating film conveying structure are respectively provided on two sides of the first thermal pressing structure, and are spatially-symmetrically arranged with respect to the first thermal pressing structure, thereby ensuring that the processing of the first and second insulating films is performed independently and without mutual interference. This also reduces the possibility of static attraction between the first insulating film and the second insulating film, thereby further ensuring the flatness of the first and second insulating films. The improved flatness facilitates proper alignment between holes formed in the first insulating film, the second insulating film and the metal conductor, and prevents misalignment resulting from wrinkling of the first and second insulating films due to uneven tension during transport. In some embodiments, the first insulating film conveying structure and the second insulating film conveying structure are arranged vertically in space. Such vertical arrangement, combined with proper spacing and conveying angles design, ensures balanced force distribution without the need for additional calculations, thereby simplifying machine installation.

It should be noted that, the first insulating film conveying structure, the second insulating film conveying structure, the metal conductor conveying structure, the first thermal pressing structure, the second thermal pressing structure and the traction structure are each independently rotatably mounted on the support structure. The support structure can be a support frame of various shapes as required. The support structure is configured to independently rotatably support the first insulating film conveying structure, the second insulating film conveying structure, the metal conductor conveying structure, the first thermal pressing structure, the second thermal pressing structure and the traction structure. The rotatable supported may be implemented using conventional rotation-fixation mechanisms, such as gears.

In some embodiments, the first insulating film and the second insulating film are made of polyethylene (PE).

In an embodiment, the laminating assembly further includes a first reinforcing structure and a second reinforcing structure. In the conveying direction, center axes of the first reinforcing structure and the second reinforcing structure are located in the plane.

The first reinforcing structure and the second reinforcing structure are configured to reinforce two ends of the target fuse simultaneously, thereby increasing reinforcement speed.

In an embodiment, the first insulating film conveying structure includes a first insulating film placement shaft 101, a first tension regulator 102, and a first punching die 103 sequentially arranged on the support structure. The first insulating film placement shaft 101 is arranged spatially symmetrically with respect to a center axis of the first insulating film conveying structure. The first tension regulator 102 is arranged spatially symmetrically with respect to the center axis of the first insulating film conveying structure. The first punching die 103 is arranged spatially symmetrically with respect to the center axis of the first insulating film conveying structure. The first insulating film placement shaft 101 is configured to detachably mount the first insulating film.

Specifically, the first insulating film placement shaft 101 is configured to hold a roll of the first insulating film. The first tension regulator 102 is configured to provide feedback regulation of tension to ensure appropriate tension and elongation of the film conveyed to the first punching die 103, thereby preventing punching position errors caused by wrinkles. The first punching die 103 is configured to perform punching according to a first punching scheme corresponding to the metal conductor. In the first insulating film conveying structure, after the roll of the first insulating film is mounted on the first insulating film placement shaft 101, a leading end of the first insulating film is sequentially fixed to the first tension regulator 102 and the first punching die 103.

Specifically, the first tension regulator 102 and the first punching die 103 are arranged spaced apart by a fixed distance from each other to ensure uniform force distribution. The fix distance can be adjusted by engineers during actual installation.

In an embodiment, the second insulating film conveying structure includes a second insulating film placement shaft 501, a second tension regulator 502, and a second punching die 503 sequentially arranged on the support structure. The second insulating film placement shaft 501 is arranged spatially symmetrically with respect to a center axis of the second insulating film conveying structure. The second tension regulator 502 is arranged spatially symmetrically with respect to the center axis of the second insulating film conveying structure. The second punching die 503 is arranged spatially symmetrically with respect to the center axis of the second insulating film conveying structure. The second insulating film placement shaft 501 is configured to detachably mount the second insulating film.

The second insulating film placement shaft 501 is configured to hold a roll of the second insulating film. The second tension regulator 502 is configured to perform feedback adjustment of tension to ensure appropriate tension and elongation of the film conveyed to the second punching die 503, thereby preventing punching position errors caused by wrinkles. The second punching die 503 is configured to perform punching according to a second punching scheme corresponding to the target metal wire. Within the second insulating film conveying structure, after the roll of the second insulating film is mounted on the second insulating film placement shaft 501, a starting end of the roll of the second insulating film is sequentially fixed to the second tension regulator 502 and the second punching die 503.

In an embodiment, the machine tool further includes an isolation film placement shaft 507. The second thermal pressing structure is provided between the second insulating film conveying structure and the traction structure. The isolation film placement shaft 507 is arranged above the second thermal pressing structure, and is configured for placement of the first isolation film and the second isolation film.

The type of the first isolation film and the second isolation film can be selected as needed.

Specifically, the second tension regulator 502 and the second punching die 503 are arranged spaced apart at a fixed distance from each other to ensure uniform force distribution. The fix distance can be adjusted by engineers during actual installation.

In an embodiment, the laminating assembly further includes a first reinforcing plate 701 and a first sensor. In the first direction, the first sensor and the first reinforcing plate 701 are sequentially arranged toward the second insulating film conveying structure.

The first sensor is configured to detect a first end of a metal conductor of the target fuse. Upon detection, the target fuse is reinforced by the first reinforcing plate 701. The first reinforcing plate 701 is mounted on the support structure using hot melt adhesive.

In an embodiment, the laminating assembly further includes a second reinforcing plate 702 and a second sensor. In the first direction, the second sensor and the second reinforcing plate 702 are sequentially arranged toward the second insulating film conveying structure.

The second sensor is configured to detect a second end of the metal conductor of the target fuse. Upon detection, the target fuse is reinforced by the second reinforcing plate 702. The second reinforcing plate 702 is mounted on the support structure.

In an embodiment, the metal conductor conveying structure includes a wire frame, a first pitch rod 301, a first wire guide roller 302 and a second pitch rod 303. The first pitch rod 301, the first wire guide roller 302 and the second pitch rod 303 are arranged sequentially and spaced apart on the wire frame. The first pitch rod 301, the first wire guide roller 302 and the second pitch rod 303 are rotatably provided on the support structure.

The first pitch rod 301 and the second pitch rod 303 are each provided with a plurality of PIN positions, and each of the plurality of PIN positions is configured to fix the metal conductor. Similarly, the first wire guide roller 302 is provided with a plurality of grooves, and each of plurality of grooves is configured to secure the metal conductor. This configuration ensures that all metal conductors in the target fuse are kept parallel to each other throughout the production line, thereby avoiding errors in pressing hole positions caused by conductor misalignment. This configuration also reduces manual alignment costs and lowers the defective rate during production.

In an embodiment, the first thermal pressing structure includes a first cooling tube set 401, a first thermal pressing roller set 404 and a second cooling tube set 402 arranged spaced apart in the first direction. The first thermal pressing structure is rotatably mounted on the support structure. The first thermal pressing roller set 404 includes at least two first thermal pressing rollers arranged spaced apart at a first predetermined distance in the second direction.

By arranging the first cooling tube set 401 and the second cooling tube set 402 both upstream and downstream of each of the at least two first thermal pressing rollers, it can be ensured that the insulating film entering the first thermal pressing rollers or the insulating film of the target fuse exiting the first thermal pressing rollers does not deform due to proximity to a heat source, thereby preventing thermal damage (e.g., scorching). As a result, the insulating films are only heated during the thermal pressing process, while active cooling is provided throughout the rest of the process. This helps maintain the performance of the insulating films and further improves the product yield. It should be noted that the first predetermined distance can be adjusted as needed, and the smaller the distance, the less thermal impact the insulating film experiences.

In an embodiment, the second thermal pressing structure includes a third cooling tube set 505, a second thermal pressing roller set 504 and a fourth cooling tube set 506 arranged spaced apart in the first direction. The second thermal pressing structure is rotatably mounted on the support structure. The second thermal pressing roller set 504 includes at least two second thermal pressing rollers arranged spaced apart at a second predetermined distance in the second direction.

By arranging the third cooling tube set 505 and the fourth cooling tube set 506 both upstream and downstream of each of the at least two second thermal pressing rollers, it can be ensured that the insulating film entering the second thermal pressing rollers or the insulating film of the finished fuse product exiting the second thermal pressing rollers does not deform due to proximity to a heat source, thereby preventing thermal damage (e.g., scorching) to the insulating films. As a result, the insulating films are only heated during the thermal pressing process, while active cooling is provided throughout the rest of the process. This helps maintain the performance of the insulating films and further improves the product yield. It should be noted that the second predetermined distance can be adjusted as needed, and the smaller the distance, the less the insulating film is affected.

In an embodiment, the traction structure includes a balancing pressure roller set 601 and a traction roller 602 arranged spaced apart in the second direction. The balancing pressure roller set 601 and the traction roller 602 are rotatably mounted on the support structure. The balancing pressure roller set 601 includes at least two balancing pressure rollers arranged spaced apart at a third predetermined distance in the second direction. The wire winding assembly 04 includes at least one reel and at least two wire guide rollers.

With the above configuration, the finished target fuse can be wound onto the reel in a consistent direction and under uniform tension. The balancing pressure roller set 601 is capable of adjusting the applied pressure to ensure that the target fuse is wound with uniform force, thereby preventing loose winding.

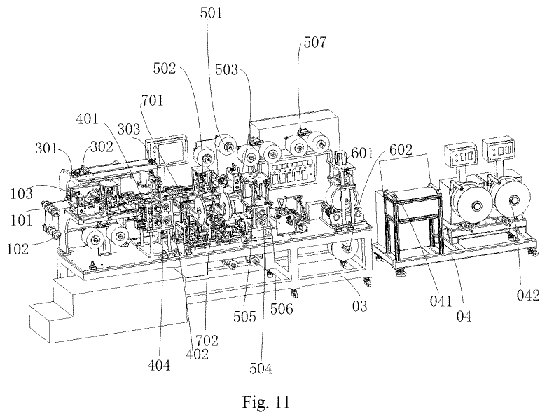

In an embodiment, as shown in FIG. 11, the machine tool further includes the isolation film placement shaft 507. The isolation film placement shaft 507 is provided above the second thermal pressing structure, and is configured for placement of the first isolation film and the second isolation film. The second thermal pressing structure includes the third cooling tube set 505, the second thermal pressing roller set 504, and the fourth cooling tube set 506. The third cooling tube set 505, the second thermal pressing roller set 504, and the fourth cooling tube set 506 are arranged spaced apart in the first direction. The second thermal pressing structure is rotatably mounted on the support structure. The second thermal pressing roller set 504 includes the at least two second thermal pressing rollers arranged spaced apart at the second predetermined distance in the second direction.

In an embodiment, the circular cutting assembly 02 includes a circular cutting mounting frame, a first circular cutting mold and a second circular cutting mold. The first circular cutting mold and the second circular cutting mold are detachably mounted on the circular cutting mounting frame. The first circular cutting mold is configured to cooperate with the second circular cutting mold. The first circular cutting mold is provided with a plurality of grooves corresponding to the number of target metal conductors in the target fuse; or the second circular cutting mold is provided with a plurality of grooves corresponding to the number of target metal conductors in the target fuse; or a plurality of grooves provided on the first circular cutting mold and the second circular cutting mold corresponds to the number of target metal conductors in the target fuse.

In the above solution, the circular cutting type can be customized according to the product requirements to accommodate the processing of various specifications. This can be achieved simply by replacing the entire circular cutting assembly 02 or part of the circular cutting assembly 02. As a result, multiple customization options can be realized at relatively low cost for small-scale production, thereby reducing equipment procurement costs.

In an embodiment, each component of the first insulating film conveying structure and the second insulating film conveying structure is arranged symmetrically with respect to the first thermal pressing assembly, so as to achieve more controllable tension balance.

In this embodiment, as shown in FIG. 11, the wire winding assembly 04 includes at least one second wire guide roller 041 and at least one reel 042 arranged in the first direction, enabling more stable winding operations. The following embodiments can be implemented on the machine tool. A method for processing a fuse provided herein will be described below by taking the machine tool as an example.

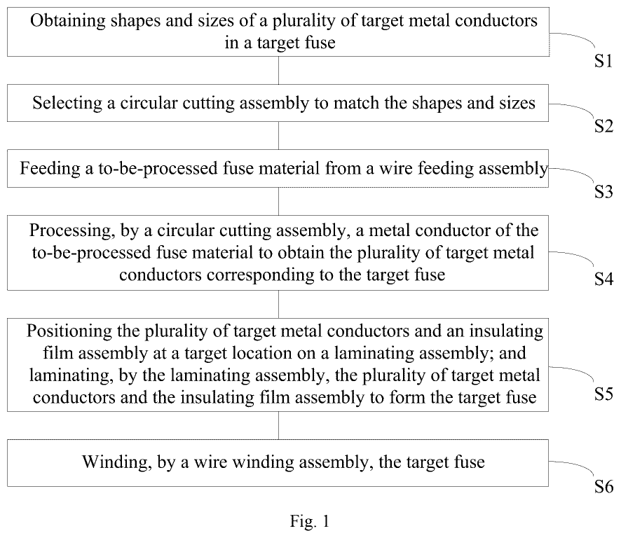

Provided herein is a fuse manufacturing method using the machine tool, the machine tool including the control device, the wire feeding assembly 01, the circular cutting assembly 02, the laminating assembly 03 and the wire winding assembly 04, the wire feeding assembly 01, the circular cutting assembly 02, the laminating assembly 03 and the wire winding assembly 04 being electrically connected to the control device. Referring to FIG. 1, the fuse manufacturing method includes the following steps.

(S1) Shapes and sizes of a plurality of target metal conductors in a target fuse are obtained.

The shapes and sizes of the plurality of target metal conductors can be input by a user or retrieved by the control device from a to-be-manufactured product. Since the to-be-processed fuse includes the plurality of target metal conductors, each of the plurality of target metal conductors may have different shape and size depending on production requirements, it is necessary to determine the shape and size of each target metal conductor in the target fuse.

(S2) The circular cutting assembly 02 is selected to match the shape and size.

The circular cutting assembly 02 may be provided with different blade grooves corresponding to the shapes and sizes of the target metal conductors, such that the target metal conductors of the to-be-processed fuse are formed accordingly. This matching process may be carried out automatically by the control device, which selects and switches among multiple circular cuttings in the circular cutting assembly 02. Alternatively, the circular cuttings may be manually replaced or switched as needed.

(S3) A to-be-processed fuse material is fed from the wire feeding assembly 01.

At this stage, the to-be-processed fuse is generally a flat oxygen-free bare copper wire. Other types of to-be-processed fuses may also be selected as needed. The to-be-processed fuse discharged from the wire feeding assembly 01 is composed of a plurality of metal conductors that have been arranged in parallel.

(S4) A metal conductor of the to-be-processed fuse is processed by the circular cutting assembly 02 to obtain the plurality of target metal conductors corresponding to the target fuse.

At this stage, the to-be-processed fuse and the plurality of target metal conductors of the target fuse are independent metal conductors. The circular cutting allows simultaneous processing of the plurality of metal conductors arranged in parallel in the to-be-processed fuse, thereby improving overall processing efficiency.

(S5) The plurality of target metal conductors and an insulating film assembly are positioned at a target location of the laminating assembly. The plurality of target metal conductors and the insulating film assembly are laminated by the laminating assembly to form the target fuse.

The target fuse is a finished product that includes the plurality of target metal conductors, the insulating film assembly and an isolation film assembly. One segment of the finished product corresponds to one complete target fuse. A spacing is provided between two adjacent target fuses, where the insulating film assembly and the isolation film assembly are enclosed to provide separation. In practical use, a cut is made at the isolation packaging to obtain individual fuses for application.

(S6) The target fuse is wound by the wire winding assembly 04.

Compared with the conventional process in which lamination is performed prior to conductor processing, the metal conductors of the fuse are processed, followed by lamination using the insulating film assembly. This sequence ensures that each target metal conductor within the target fuse is individually insulated and precisely formed, thereby allowing effective isolation through the insulating film assembly. As a result, the processed target fuses are protected from exposure to air, reducing the risk of oxidation. Furthermore, the target fuses are wound into rolls to facilitate storage and transportation. Proper winding further helps to prevent bending or damage during handling throughout the production process.

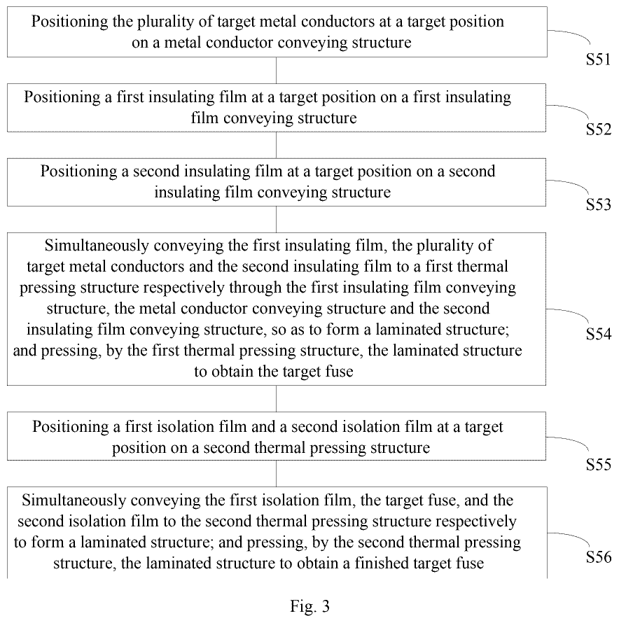

In an embodiment, the insulating film assembly includes a first insulating film and a second insulating film, and the isolation film includes a first isolation film and a second isolation film. As shown in FIG. 3, Step S5 includes the following steps.

(S51) The plurality of target metal conductors are positioned at a target position on the metal conductor conveying structure.

By confirming that the target metal conductors are positioned at the target position on the metal conductor conveying structure, the accuracy of target metal conductors positioning can be ensured. This confirmation process may be performed manually, in which case the operator activates the corresponding metal conductor conveying structure after visual verification. Alternatively, sensors may be used to detect whether the target position of the metal conductor conveying structure are occupied by the target metal conductors. It should be noted that, since the plurality of metal conductors are involved at this stage, the position of each metal conductor needs to be confirmed to ensure that all conductors are correctly positioned.

(S52) The first insulating film is positioned at a target position on the first insulating film conveying structure.

The first insulating film is provided in the form of a roll, and is positioned either manually or via automation at the target position on the first insulating film conveying structure. The first insulating film roll needs to be properly wound to enable its unwinding and positioning. This process involves confirming multiple positions. The first insulating film conveying structure may be activated either manually after operator-assisted confirmation, or automatically by sensors installed at key positions that detect whether the first insulating film is present at all required locations. (S53) The second insulating film is positioned at a target position on the second insulating film conveying structure.

The second insulating film is provided in the form of a roll, and is positioned either manually or via automation at the target position on the second insulating film conveying structure. The second insulating film roll needs to be properly wound to enable its unwinding and positioning. This process involves confirming multiple positions. The second insulating film conveying structure may be activated either manually after operator-assisted confirmation, or automatically by sensors installed at key positions that detect whether the second insulating film is present at all required locations.

(S54) The first insulating film, the plurality of target metal conductors, and the second insulating film are simultaneously conveyed to the first thermal pressing structure respectively through the first insulating film conveying structure, the metal conductor conveying structure, and the second insulating film conveying structure, so as to form a laminated structure. The laminated structure is pressed by the first thermal pressing structure to obtain the target fuse.

Through the above confirmation steps, the target fuse can be reliably formed in a single thermal pressing process. By repeatedly confirming that each target material, including the target metal conductors, the first insulating film, and the second insulating film, is positioned correctly, a stable production and feeding state can be maintained. This ensures accurate alignment between the punched first and the second insulating film and the corresponding metal conductors during the pressing process, which helps prevent defects such as bending, curling, or overlapping that may occur during material routing and transfer. As a result, the yield rate of the produced fuses can be effectively improved.

In an embodiment, the fuse manufacturing method further includes the following steps.

(S55) The first isolation film and the second isolation film are positioned at a target position on the second thermal pressing structure.

The first isolation film and the second isolation film are provided in the form of first isolation film roll and second isolation film roll, respectively. These rolls may be installed manually or automatically at the target position on the second thermal pressing structure. The first and second isolation film rolls are wound appropriately to allow unwinding, ensuring that the first and second isolation films are delivered to their designated positions. This process involves confirmation of multiple positions. The second thermal pressing structure may be activated either manually after operator-assisted confirmation, or automatically by sensors installed at key locations that detect the presence of the first and second isolation films at the designated positions.

(S56) The first isolation film, the target fuse, and the second isolation film are simultaneously conveyed to the second thermal pressing structure respectively to form a laminated structure. The laminated structure is pressed by the second thermal pressing structure to obtain a finished target fuse.

It should be noted that the finished target fuse is a further protected product based on the previously formed fuse, providing enhanced isolation. Depending on the specific application, alternative functional films may also be selected for secondary thermal pressing.

In the above embodiment, by implementing the confirmation steps described, the secondary thermal pressing of the target fuse can be reliably achieved. Repeated confirmation of the positions of the target fuse, the first isolation film, and the second isolation film ensures that all materials remain in a stable production and feeding state. This guarantees proper alignment between the first isolation film, the second isolation film and the target fuse during the pressing process, thereby avoiding issues such as bending, curling, or overlapping of materials during routing and transportation. As a result, the yield of the finished fuses can be further improved.

In an embodiment, the laminating assembly further includes a first reinforcing structure and a second reinforcing structure. In the conveying direction, center axes of the first reinforcing structure and the second reinforcing structure are located in the plane. The fuse manufacturing method further includes the following steps.

The target fuse is reinforced by the first reinforcing structure and the second reinforcing structure.

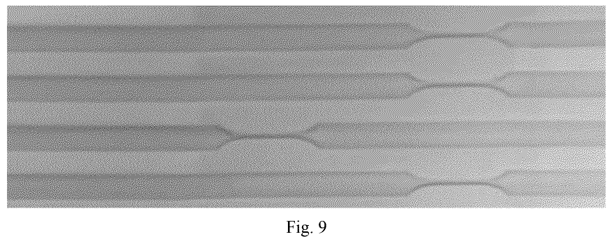

Specifically, the reinforcement operation enhances the strength at the ends of the processed fuse, prevents the circular-cutting-processed metal conductor section from becoming a mechanical weak point and causing damage, and ensures even stress distribution in the reinforced area during final winding. The reinforcement effect is illustrated in FIG. 9.

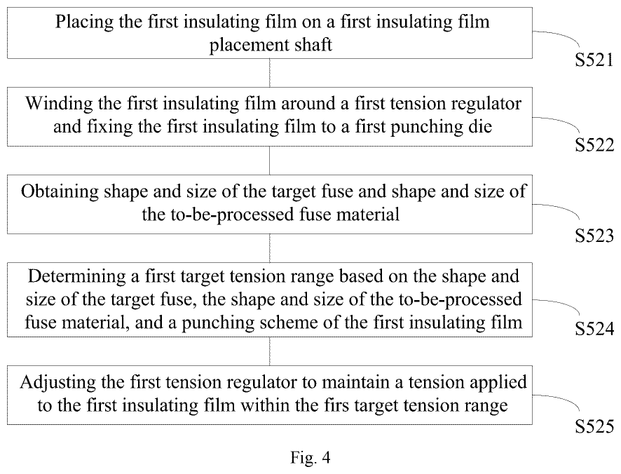

In an embodiment, as shown in FIG. 4, the first insulating film conveying structure includes a first insulating film placement shaft 101, a first tension regulator 102 and a first punching die 103 sequentially arranged on the support structure. The first insulating film placement shaft 101 is arranged spatially symmetrically with respect to a center axis of the first insulating film conveying structure. The first tension regulator 102 is arranged spatially symmetrically with respect to the center axis of the first insulating film conveying structure. The first punching die 103 is arranged spatially symmetrically with respect to the center axis of the first insulating film conveying structure. The first insulating film placement shaft 101 is configured for detachably mounting the first insulating film. The step S52 includes the following steps.

(S521) The first insulating film is placed on the first insulating film placement shaft 101.

This confirmation may be performed either by sensor detection or manually, with the confirmation result fed back to the machine.

(S522) The first insulating film is wound around the first tension regulator 102 and fixed to the first punching die 103.

(S523) Shape and size of the target fuse and shape and size of the to-be-processed fuse material are obtained.

(S524) A first target tension range is determined based on the shape and size of the target fuse, the shape and size of the to-be-processed fuse material, and a punching scheme of the first insulating film.

As the processed target fuse may include recesses or trimmed areas, which tend to be structurally weaker, and the punched first insulating film may contain stress concentration zones, the tension must be carefully set to avoid uneven stress. Accordingly, the first target tension range is generally adjusted downward. The specific values of the first target tension range may be calculated and preset by the user.

(S525) The first tension regulator 102 is adjusted to maintain a tension applied to the first insulating film within the first target tension range.

Through the above steps, balanced tension on the first insulating film can be ensured, preventing deformation caused by uneven stress. Additionally, the first tension regulator 102 levels the first insulating film, ensuring that it remains in the same plane, thereby further minimizing the risk of deformation.

In an embodiment, the laminating assembly further includes a first reinforcing plate 701 and a first sensor. In the first direction, the first sensor and the first reinforcing plate 701 are sequentially arranged toward the second insulating film conveying structure.

The fuse manufacturing method further includes the following step.

Upon detection of the target fuse by the first sensor, the first reinforcing plate 701 is applied to a first end of the target fuse.

The reinforcement operation improves the structural strength at the end of the processed fuse, prevents the circular-cutting-processed metal conductor section from becoming a mechanical weak point and causing damage, ensures even stress distribution in the reinforced area during final coiling. The reinforcement effect is illustrated in FIG. 9.

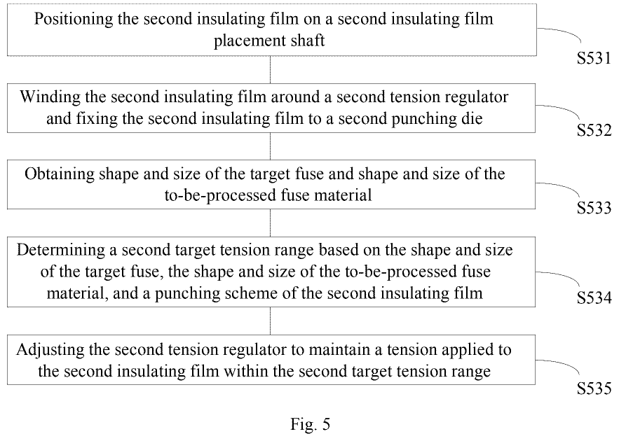

In an embodiment, as shown in FIG. 5, the second insulating film conveying structure includes a second insulating film placement shaft 501, a second tension regulator 502, and a second punching die 503 sequentially arranged on the support structure. The second insulating film placement shaft 501 is arranged spatially symmetrically with respect to a center axis of the second insulating film conveying structure. The second tension regulator 502 is arranged spatially symmetrically with respect to the center axis of the second insulating film conveying structure. The second punching die 503 is arranged spatially symmetrically with respect to the center axis of the second insulating film conveying structure. The second insulating film placement shaft 501 is configured for detachably mounting the second insulating film. The step S53 includes the following steps.

(S531) The second insulating film is positioned on the second insulating film placement shaft 501.

This confirmation may be performed via sensor detection or manually, with feedback sent to the control system.

(S532) The second insulating film is wound around the second tension regulator 502 and fixed to the second punching die 503.

(S533) Shape and size of the target fuse and shape and size of the to-be-processed fuse material are obtained.

(S534) A second target tension range is determined based on the shape and size of the target fuse, the shape and size of the to-be-processed fuse material, and a punching scheme for the second insulating film.

Since the punched first insulating film also has areas prone to stress concentration, the tension needs to be determined based on these factors to avoid uneven stress on the first insulating film, which means appropriately reducing the first target tension range.

(S535) The second tension regulator 502 is adjusted to maintain a tension applied to the second insulating film within the second target tension range.

Due to depressions or cutouts in the processed target fuse, the structure becomes mechanically weaker, and the punched second insulating film also has areas prone to stress concentration. Therefore, the tension must be determined based on these factors to ensure even stress distribution in the second insulating film, which requires appropriately reducing the second target tension range. The specific values for the second target tension range can be calculated and set by the user.

In an embodiment, the laminating assembly further includes a second reinforcing plate 702 and a second sensor. In the first direction, the second sensor and the second reinforcing plate 702 are sequentially arranged toward the second insulating film conveying structure.

The fuse manufacturing method further includes the following step.

Upon detection of the target fuse by the second sensor, the second reinforcing plate 702 is applied to a second end of the target fuse.

The reinforcement operation improves the structural strength at the end of the processed fuse, prevents the circular-cutting-processed metal conductor section from becoming a mechanical weak point and causing damage, ensures even stress distribution in the reinforced area during final coiling. The reinforcement effect is illustrated in FIG. 9.

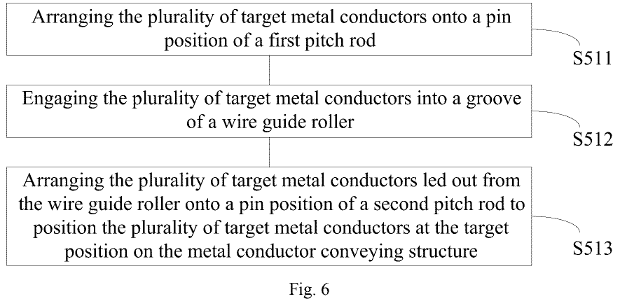

In this embodiment, as shown in FIG. 6, the metal conductor conveying structure includes the wire frame, the first pitch rod 301, the first wire guide roller 302 and the second pitch rod 303. The first pitch rod 301, the first wire guide roller 302 and the second pitch rod 303 are arranged sequentially and spaced apart on the wire frame. The metal conductor conveying structure is rotatably mounted on the support structure. The step S51 includes the following steps.

(S511) The plurality of target metal conductors are arranged onto a pin position of the first pitch rod 301.

(S512) The plurality of target metal conductors are engaged into a groove of the first wire guide roller 302.

(S513) The plurality of target metal conductors led out from the first wire guide roller 302 are arranged into a pin position of the second pitch rod 303 to position the plurality of target metal conductors at the target position on the metal conductor conveying structure.

In this scheme, confirmation at each position can be performed by sensors installed at each pin position and groove. This arrangement ensures that the different target metal conductors are arranged in parallel at any position within the metal conductor conveying structure, further improving the stability of the finished product.

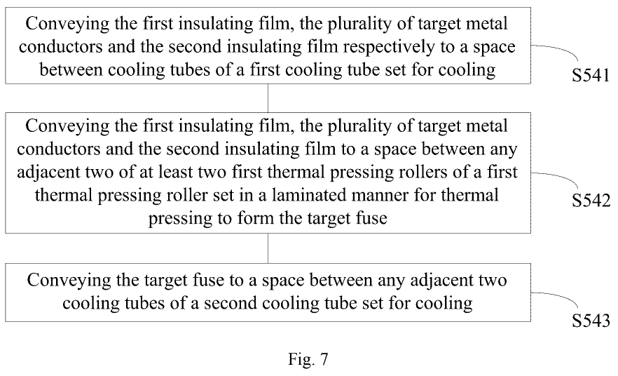

In this embodiment, as shown in FIG. 7, the first thermal pressing structure includes the first cooling tube set 401, the first thermal pressing roller set 404, and the second cooling tube set 402 arranged spaced apart in the first direction. The first thermal pressing structure is rotatably mounted on the support structure. The first thermal pressing roller set 404 includes at least two first thermal pressing rollers arranged spaced apart at a first predetermined distance in the second direction.

The step S54 includes the following steps.

(S541) The first insulating film, the plurality of target metal conductors and the second insulating film are respectively conveyed to a space between cooling tubes of the first cooling tube set 401 for cooling.

(S542) The first insulating film, the plurality of target metal conductors and the second insulating film are conveyed in a laminated manner to a space between any adjacent two of the at least two first thermal pressing rollers of the first thermal pressing roller set 404 for thermal pressing to form the target fuse.

(S543) The target fuse is conveyed to a space between any adjacent two cooling tubes of the second cooling tube set 402 for cooling.

By means of the above process, thermal deformation of the first and second insulating films during entry into and exit from the first thermal pressing roller set 404 can be avoided. In addition, heat damage to the first and second insulating films caused by thermal conduction from the metal conductors can also be prevented, thereby ensuring the flatness, sealing performance and dimensional stability of the final product.

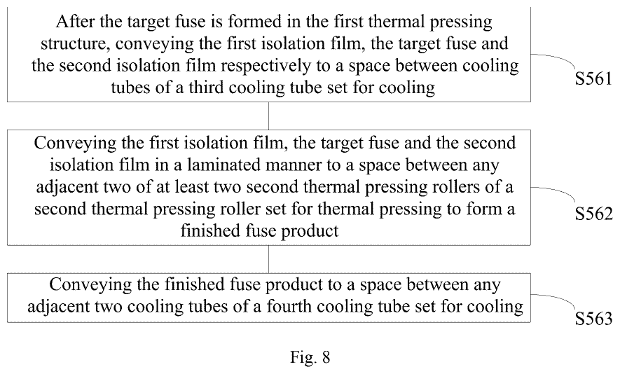

In this embodiment, as shown in FIG. 8, the second thermal pressing structure includes the third cooling tube set 505, the second thermal pressing roller set 504, and the fourth cooling tube set arranged spaced apart in the first direction. The second thermal pressing structure is rotatably mounted on the support structure. The second thermal pressing roller set 504 includes at least two second thermal pressing rollers arranged spaced apart at a second predetermined distance in the second direction.

The machine tool further includes an isolation film placement shaft. The second thermal pressing structure is positioned between the second insulating film conveying structure and the traction structure. The isolation film placement shaft is provided above the second thermal pressing structure, and is configured for placement of the first isolation film and the second isolation film.

The fuse manufacturing method further includes the following steps.

(S561) After the target fuse is formed in the first thermal pressing structure, the first isolation film, the target fuse and the second isolation film are respectively conveyed a space between cooling tubes of the third cooling tube set 505 for cooling.

(S562) The first isolation film, the target fuse, and the second isolation film are conveyed in a laminated manner to a space between any adjacent two of at least two second thermal pressing rollers of the second thermal pressing roller set 504 for thermal pressing to form a finished fuse product.

(S563) The finished fuse product is conveyed to a space between any adjacent two cooling tubes of the fourth cooling tube set for cooling.

This arrangement helps prevent thermal deformation of the first and second isolation films when entering and exiting the second thermal pressing roller set 504. It also mitigates the risk of thermal damage to the first isolation film, the second isolation film, the first insulating film, and the second insulating film caused by heat conduction from the target metal conductors. As a result, the flatness, sealing performance, and dimensional stability of the final product are effectively ensured.

In an embodiment, the traction structure includes a balancing pressure roller set 601 and a traction roller 602 arranged spaced apart in the second direction. The balancing pressure roller set 601 and the traction roller 602 are rotatably provided on the support structure. The balancing pressure roller set 601 includes at least two balancing pressure rollers arranged spaced apart at a third predetermined distance in the second direction. The wire winding assembly 04 includes at least one reel and at least two wire guide rollers.

The step S6 includes the following steps.

A plurality of target fuses are prepared and processed into a target fuse strip. The target fuse strip is wound around each of the at least two balancing pressure rollers to position a tail end of the target fuse strip at an inlet side of the balancing pressure roller set 601 and a head end of the target fuse strip at an outlet side of the balancing pressure roller set 601.

The target fuse strip is wound onto the at least one reel via the at least two wire guide rollers.

In the above scheme, the processed target fuses may exhibit recessed or thinned sections, resulting in reduced mechanical strength and a higher susceptibility to tension-induced deformation during production. By means of the balancing pressure roller set 601, pressure is evenly distributed, thereby facilitating tension balancing and ensuring consistent winding tension in the subsequent rolling process.

In an embodiment, in a region near the first thermal pressing structure, a conveying surface of the metal conductor conveying structure is respectively parallel to a conveying surface of the first insulating film conveying structure and a conveying surface of the second insulating film conveying structure.

This facilitates subsequent adjustment of the tension balance between the first and the second insulating film conveying structures, ensuring lamination tightness, reducing the need for fine-tuning during industrial production, and thereby improving the yield rate.

It should be understood that the numerical order of the steps in the above embodiments does not imply any limitation on the order of execution. The sequence of the processes should be determined based on their functions and inherent logic, and should not be construed as limiting the implementation of the embodiments of the present disclosure.

Described embodiments are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A fuse manufacturing method using a machine tool, the machine tool comprising a control device, a wire feeding assembly, a circular cutting assembly, a laminating assembly and a wire winding assembly; the wire feeding assembly, the circular cutting assembly, the laminating assembly and the wire winding assembly being electrically connected to the control device; and the fuse manufacturing method comprising:
obtaining shape and size of each of a plurality of target metal conductors in a target fuse;
selecting the circular cutting assembly to match the shape and size;
feeding a to-be-processed fuse material from the wire feeding assembly;
processing, by the circular cutting assembly, a metal conductor of the to-be-processed fuse material to obtain the plurality of target metal conductors corresponding to the target fuse;
positioning the plurality of target metal conductors and an insulating film assembly at a target location on the laminating assembly; and laminating, by the laminating assembly, the plurality of target metal conductors and the insulating film assembly to form the target fuse; and
winding, by the wire winding assembly, the target fuse.

2. The fuse manufacturing method of claim 1, wherein the laminating assembly comprises a support structure, a first insulating film conveying structure, a second insulating film conveying structure, a metal conductor conveying structure, a first thermal pressing structure, and a traction structure;
the support structure is sequentially provided with the first insulating film conveying structure, the first thermal pressing structure, the second insulating film conveying structure, and the traction structure in a first direction;
the support structure is sequentially provided with the first insulating film conveying structure and the metal conductor conveying structure in a second direction;
the first insulating film conveying structure and the second insulating film conveying structure are respectively provided on two sides of the first thermal pressing structure, and are spatially-symmetrically arranged with respect to the first thermal pressing structure; and
center axes of the first insulating film conveying structure, the second insulating film conveying structure, the metal conductor conveying structure, the first thermal pressing structure and the traction structure are located in a plane in a conveying direction.

3. The fuse manufacturing method of claim 2, wherein the insulating film assembly comprises a first insulating film and a second insulating film both made of polyethylene (PE); and
the step of positioning the plurality of target metal conductors and the insulating film assembly at the target location on the laminating assembly, and laminating, by the laminating assembly, the plurality of target metal conductors and the insulating film assembly to form the target fuse comprises:
positioning the plurality of target metal conductors at a target position on the metal conductor conveying structure;
positioning the first insulating film at a target position on the first insulating film conveying structure;
positioning the second insulating film at a target position on the second insulating film conveying structure; and
simultaneously conveying the first insulating film, the plurality of target metal conductors and the second insulating film to the first thermal pressing structure respectively through the first insulating film conveying structure, the metal conductor conveying structure and the second insulating film conveying structure, so as to form a laminated structure; and pressing, by the first thermal pressing structure, the laminated structure to obtain the target fuse.

4. The fuse manufacturing method of claim 3, wherein the laminating assembly further comprises a first reinforcing structure and a second reinforcing structure;
in the conveying direction, center axes of the first reinforcing structure and the second reinforcing structure are located in the plane; and
the fuse manufacturing method further comprises:
reinforcing the target fuse by the first reinforcing structure and the second reinforcing structure.

5. The fuse manufacturing method of claim 3, wherein the first insulating film conveying structure comprises an insulating film placement shaft, a tension regulator, and a punching die sequentially arranged on the support structure;
the insulating film placement shaft is arranged spatially symmetrically with respect to a center axis of the first insulating film conveying structure; the tension regulator is arranged spatially symmetrically with respect to the center axis of the first insulating film conveying structure; and the punching die is arranged spatially symmetrically with respect to the center axis of the first insulating film conveying structure;
the insulating film placement shaft is configured to detachably mount the first insulating film; and
the step of positioning the first insulating film at the target position on the first insulating film conveying structure comprises:
placing the first insulating film on the insulating film placement shaft;
winding the first insulating film around the tension regulator and fixing the first insulating film to the punching die;
obtaining shape and size of the target fuse and shape and size of the to-be-processed fuse material;
determining a target tension range based on the shape and size of the target fuse, the shape and size of the to-be-processed fuse material, and a punching scheme of the first insulating film; and
adjusting the tension regulator to maintain a tension applied to the first insulating film within the target tension range.

6. The fuse manufacturing method of claim 3, wherein the second insulating film conveying structure comprises an insulating film placement shaft, a tension regulator and a punching die sequentially arranged on the support structure;
the insulating film placement shaft is arranged spatially symmetrically with respect to a center axis of the second insulating film conveying structure; the tension regulator is arranged spatially symmetrically with respect to the center axis of the second insulating film conveying structure; and the punching die is arranged spatially symmetrically with respect to the center axis of the second insulating film conveying structure;
the insulating film placement shaft is configured to detachably mount the second insulating film; and
the step of positioning the second insulating film at the target position on the second insulating film conveying structure comprises:
positioning the second insulating film on the insulating film placement shaft;
winding the second insulating film around the tension regulator and fixing the second insulating film to the punching die;
obtaining shape and size of the target fuse and shape and size of the to-be-processed fuse material;
determining a target tension range based on the shape and size of the target fuse, the shape and size of the to-be-processed fuse material, and a punching scheme of the second insulating film; and
adjusting the tension regulator to maintain a tension applied to the second insulating film within the target tension range.

7. The fuse manufacturing method of claim 3, wherein the metal conductor conveying structure comprises a wire frame, a first pitch rod, a wire guide roller and a second pitch rod; and the first pitch rod, the wire guide roller and the second pitch rod are arranged sequentially and spaced apart on the wire frame;
the first pitch rod, the wire guide roller and the second pitch rod are rotatably provided on the support structure; and
the step of positioning the plurality of target metal conductors at the target position on the metal conductor conveying structure comprises:
arranging the plurality of target metal conductors onto a pin position of the first pitch rod;
engaging the plurality of target metal conductors into a groove of the wire guide roller; and
arranging the plurality of target metal conductors led out from the wire guide roller onto a pin position of the second pitch rod to position the plurality of target metal conductors at the target position on the metal conductor conveying structure.

8. The fuse manufacturing method of claim 3, wherein the first thermal pressing structure comprises a first cooling tube set, a thermal pressing roller set and a second cooling tube set arranged spaced apart in the first direction;
the first thermal pressing structure is rotatably mounted on the support structure;
the thermal pressing roller set comprises at least two thermal pressing rollers arranged spaced apart at a predetermined distance in the second direction; and
the step of simultaneously conveying the first insulating film, the plurality of target metal conductors and the second insulating film to the first thermal pressing structure respectively through the first insulating film conveying structure, the metal conductor conveying structure and the second insulating film conveying structure to form a laminated structure, and pressing, by the first thermal pressing structure, the laminated structure to obtain the target fuse comprises:
conveying the first insulating film, the plurality of target metal conductors and the second insulating film respectively to a space between cooling tubes of the first cooling tube set for cooling;
conveying the first insulating film, the plurality of target metal conductors and the second insulating film to a space between any adjacent two of the at least two thermal pressing rollers in a laminated manner for thermal pressing to form the target fuse; and
conveying the target fuse to a space between any adjacent two cooling tubes of the second cooling tube set for cooling.

9. The fuse manufacturing method of claim 3, wherein the machine tool further comprises a second thermal pressing structure and an isolation film placement shaft;
the second thermal pressing structure is provided between the second insulating film conveying structure and the traction structure;
the isolation film placement shaft is provided above the second thermal pressing structure, and is configured for placement of a first isolation film and a second isolation film;
the second thermal pressing structure comprises a first cooling tube set, a thermal pressing roller set and a second cooling tube set arranged spaced apart in the first direction;
the second thermal pressing structure is rotatably mounted on the support structure;
the thermal pressing roller set comprises at least two thermal pressing rollers arranged spaced apart at a first predetermined distance in the second direction; and
the fuse manufacturing method further comprises:
after the target fuse is formed in the first thermal pressing structure, conveying the first isolation film, the target fuse and the second isolation film respectively to a space between cooling tubes of the first cooling tube set for cooling;
conveying the first isolation film, the target fuse and the second isolation film in a laminated manner to a space between any adjacent two of the at least two thermal pressing rollers for thermal pressing to form a finished fuse product; and
conveying the finished fuse product to a space between any adjacent two cooling tubes of the second cooling tube set for cooling.

10. The fuse manufacturing method of claim 9, wherein the traction structure comprises a balancing pressure roller set and a traction roller arranged spaced apart in the second direction; and the balancing pressure roller set and the traction roller are rotatably provided on the support structure;
the balancing pressure roller set comprises at least two balancing pressure rollers arranged spaced apart at a second predetermined distance in the second direction;
the wire winding assembly comprises at least one reel and at least two wire guide rollers;
the step of winding the target fuse by the wire winding assembly comprises:
preparing a plurality of target fuses, and processing the plurality of target fuses into a target fuse strip;
winding the target fuse strip around each of the at least two balancing pressure rollers to position a tail end of the target fuse strip at an inlet side of the balancing pressure roller set and a head end of the target fuse strip at an outlet side of the balancing pressure roller set; and
winding the target fuse strip onto the at least one reel via the at least one wire guide roller.
